(19) United States
(12) Patent Application Publication
(10) Pub. No.: US 2006/0036980 A1
(43) Pub. Date: Feb. 16, 2006

(54) Method and apparatus for jitter analysis and program therefor

(75) Inventor: Susumu Kobayashi, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/183,070

(22) Filed: Jul. 18, 2005

(30) Foreign Application Priority Data
Jul. 20, 2004 (JP) 2004-211168

(51) Int. Cl. G06F 17/50

(52) U.S. Cl. 716/4; 703/14

(57) ABSTRACT

A method, an apparatus and a program for comprehensively analyzing the power supply noise and consequent jitter for external output signals of the LSI in real time. From LSI layout designing data 601, the resistance, capacitance and inductance of the power supply interconnection are extracted to formulate a power supply LRC model 606. An analysis model formulating unit 812 connects a transistor model 610, a noise source model 607, a silicon substrate model 608 and a package/board (printed circuit board) model 611 to formulate a model for analysis of the power supply noise 813 and a model for jitter analysis 817. An analysis unit 814 acquires power supply noise waveform data 816 by first simulation and also acquires jitter analysis data 815 using power supply noise waveform data 816 by second simulation.

### FIELD OF THE INVENTION

This invention relates to a method, an apparatus and a program for analyzing the jitter. More particularly, it relates to a method, an apparatus and a program for analyzing the jitter ascribable to the noise of the power supply of a semiconductor integrated circuit.

### BACKGROUND OF THE INVENTION

In keeping up with increase in the system operating speed in recent years, the necessity for jitter analysis is increasing. In particular, in keeping up with increase in the data communication speed among LSIs (large scale integrated circuits), the need for analyzing the jitter (I/O jitter) of LSI output signals is increasing. In such analysis, it is necessary to analyze the power supply noise as a major factor responsible for jitter. FIG. 2 depicts a circuit diagram indicating that jitter may be produced by the power supply noise. In the circuit of FIG. 2, clock signals generated in a PLL unit 21, are distributed, by a clock tree 22, and the clock signals are output at an output buffer unit 23. In this circuit, variations in the power supply voltage of the PLL unit 21 and in the power supply voltage of the output buffer unit 23 due to power supply noise affect the jitter of the clock signals output from the output buffer unit 23. If, in an attempt to analyze this jitter, a model of an on-chip power supply grid is generated, using a commercially available LPE (Layout Parasitic Extraction) tool, to carry out circuit simulation inclusive of the model, on SPICE, it is in general not possible to complete the analysis within a practical time period, because of excessive circuit scale.

In Patent Document 1, there is disclosed a technique for carrying out simulation for a circuit system, including an oscillator, using a functional model which has modeled the phenomenon of jitter generation when noise is applied to an oscillator.

In Non-Patent Document 1, which is not directly relevant to the method or apparatus for jitter analysis, there is disclosed a technique in which the power supply noise responsible for jitter is simulated on the presupposition that the power supply interconnection is of a meshed configuration.

Patent Document 1

JP Patent Kokai Publication No. JP-P2003-216676A

Non-Patent Document 1

Jiro IWAI et al., “Development of VLSI power supply analysis system PowerSpective”, Proceedings of DA Symposium 2003, Information Processing Society of Japan, July 2003, pp. 49-54

### SUMMARY OF THE DISCLOSURE

However, there lacks up to now a method, an apparatus or a program whereby both the power supply noise generated and the jitter attributable thereto may be comprehensively analyzed within a reasonable length of time. Thus there is much to be desired in the art in this connection.

According to an aspect of the present invention, there is provided a method for analyzing jitter. The method comprises the steps of: formulating a power supply LRC model by extracting interconnection resistance, interconnection capacitance and interconnection inductance of a power supply from circuit layout data, formulating an analysis model by connecting a transistor model to the power supply LRC model, and effecting circuit simulation for the analysis model to output jitter analysis data.

In the jitter analysis method according to the present invention the analysis model comprises a power supply noise analysis model for simulating the power supply noise. In the jitter analysis method, the step of effecting circuit simulation for the analysis model to output jitter analysis data includes a sub-step of effecting first circuit simulation for the power supply noise analysis model to find a power supply noise waveform; a sub-step of formulating a jitter analysis model of a circuit as a subject of jitter analysis; and a sub-step of effecting second circuit simulation, using a power supply noise waveform as found by the first circuit simulation, to output the jitter analysis data.

In another aspect of the present invention, there is provided an apparatus for analyzing the jitter. The apparatus comprises a power supply LRC model extracting means for formulating a power supply LRC model by extracting interconnection resistance, interconnection capacitance and interconnection inductance of a power supply from circuit layout data, an analysis model formulating means for formulating an analysis model by connecting a transistor model to the power supply LRC model, and analyzing means for effecting circuit simulation for the analysis model to output jitter analysis data.

The analysis model formulating means includes power supply noise analysis model formulating means for formulating a power supply noise analysis model for simulating power supply noise, and a jitter analysis model formulating means for formulating a jitter analysis model for simulating the jitter analysis. The jitter analyzing means includes power supply noise simulating means for effecting circuit simulation for the power supply noise analysis model to output a power supply noise waveform, and jitter analysis simulating means for effecting circuit simulation using the power supply noise waveform for the jitter analysis model to output a jitter waveform.

The method and the apparatus according to the present invention may also be implemented by a computer program.

The meritorious effects of the present invention are summarized as follows.

According to the present invention, the power supply noise and the jitter attributable to the power supply noise may comprehensively be analyzed for a circuit such as LSI.

### BRIEF DESCRIPTION OF THE DRAWINGS

FIG. 1 is a flowchart for a method for jitter analysis according to a first embodiment of the present invention.

FIG. 2 illustrates the relationship between the power supply noise and jitter.

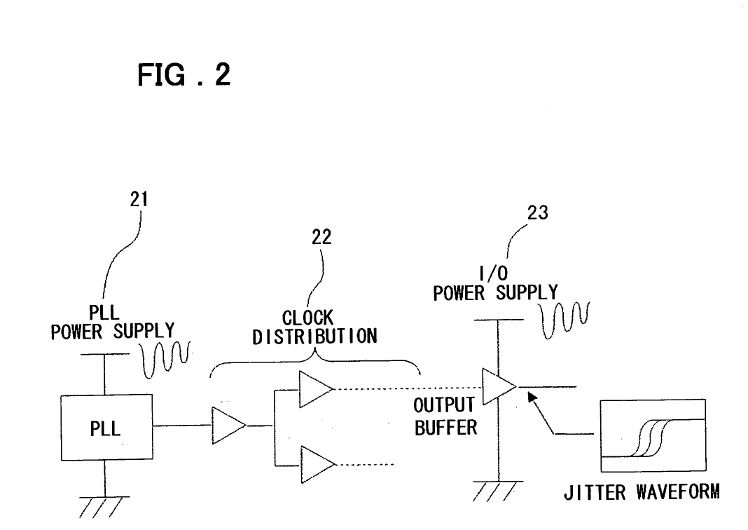

FIG. 3 shows a model for analysis of the first embodiment of the present invention.

FIG. 4 illustrates division of the power supply interconnection layout embodying the present invention.

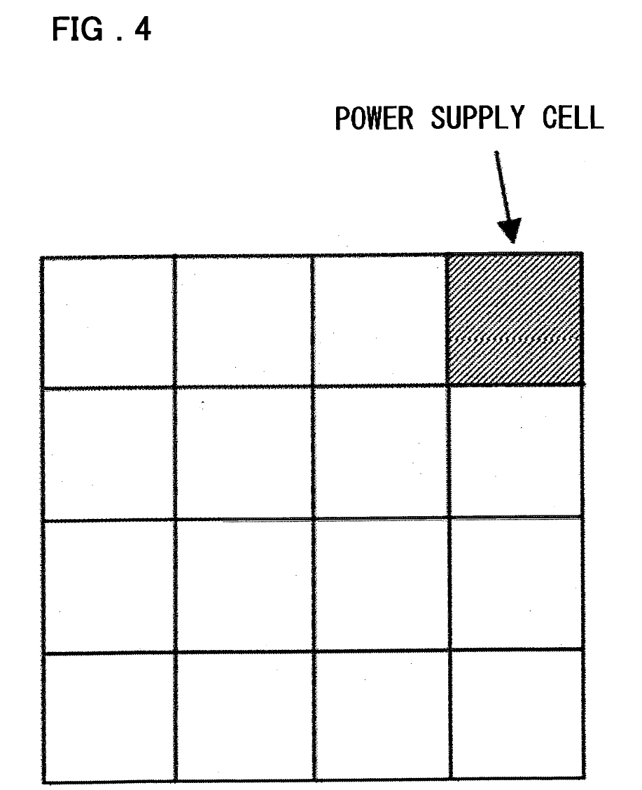

FIG. 5 shows a model of a power supply cell embodying the present invention.

FIG. 6 is a block diagram of an apparatus for jitter analysis of the first embodiment of the present invention.

FIG. 7 is a flowchart for a method for jitter analysis of a second embodiment of the present invention.

FIG. 8 is a block diagram of an apparatus for jitter analysis of the second embodiment of the present invention.

FIGS. 9A, 9B and 9C illustrate the division into small areas of the layout of the LSI power supply embodying the present invention.

FIG. 10 shows a model of a power supply interconnection embodying the present invention.

FIG. 11 shows the power supply LRC model in which a capacitor device is introduced into the power supply interconnection embodying the present invention.

FIGS. 12A and 12B show a substrate model embodying the present invention.

FIG. 13 shows a power supply LRC model, the substrate model is connected to, embodying the present invention.

FIG. 14 illustrates the algorithm of a power supply cell pattern matching embodying the present invention.

FIGS. 15A and 15B show the connection of a noise source model embodying the present invention.

FIG. 16 is a waveform diagram of the noise source model current embodying the present invention.

FIG. 17 shows the connection of the static capacitance to a power supply interconnection embodying the present invention.

FIG. 18 shows connection of a transistor model to the power supply interconnection embodying the present invention.

FIGS. 19A and 19B show an example of a package/board model embodying the present invention.

FIGS. 20A and 20B show a dual stage analysis model according to a second embodiment of the present invention.

FIG. 21 shows a functional-block-based jitter analysis model according to a third embodiment of the present invention.

FIG. 22 is a flowchart for illustrating the method for jitter analysis of the third embodiment of the present invention.

FIG. 23 is a block diagram of an apparatus for jitter analysis of the third embodiment of the present invention.

### PREFERRED EMBODIMENTS OF THE INVENTION

For clarifying the above and other features of the present invention, certain preferred embodiments of the present invention will now be explained in detail with reference to the drawings.

### FIRST EMBODIMENT

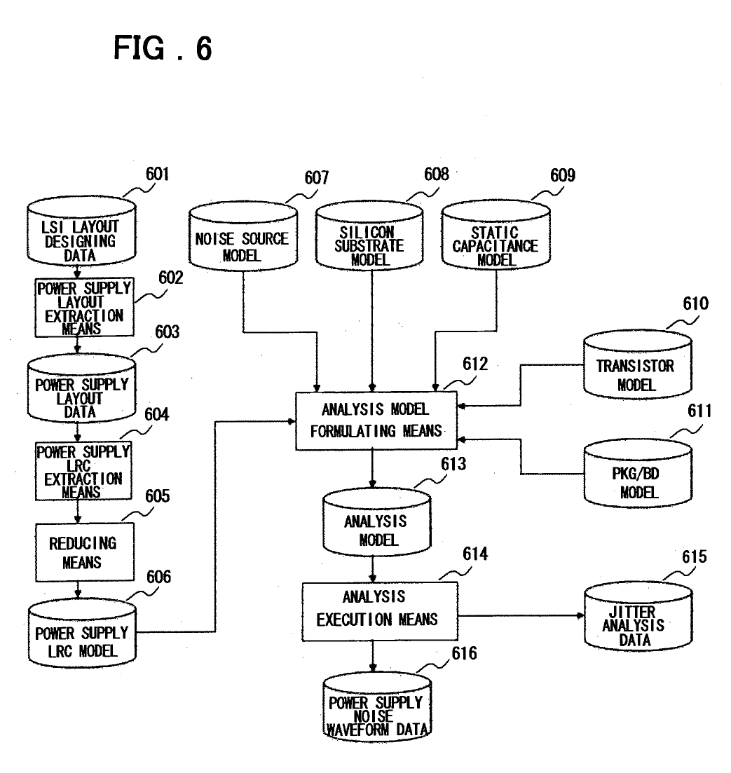

FIG. 6 depicts a block diagram of an apparatus for jitter analysis according to a first embodiment of the present invention. Power supply layout extraction means 602, power supply LRC extraction means 604 and reducing means 605 together make up power supply analysis model extraction means adapted for extracting interconnection resistance, interconnection capacitance and interconnection inductance to output a power supply LRC model. The power supply layout extraction means 602 extracts the layout of the power supply interconnection from LSI layout design data 601 to output a power supply layout data 603. The power supply LRC extraction means 604 extracts the interconnection resistance, interconnection capacitance and the interconnection inductance of the power supply from power supply layout data 603 to form a power supply LRC model. The reducing means reduces the power supply LRC model as necessary to output a reduced power supply LRC model 606.

An analysis model formulating means 612 then connects a noise source model 607, a silicon substrate model 608, a static capacitance model 609, a transistor model 610 and a package/board model to the power supply LRC model 606 to output an analysis model 613 for analysis of both the power supply noise and jitter.

An analysis execution means 614 carries out circuit simulation on the analysis model 613 to find a power supply noise waveform and a jitter waveform together, to output jitter analysis data 615.

The processing flow of a first embodiment of the present invention will now be explained.

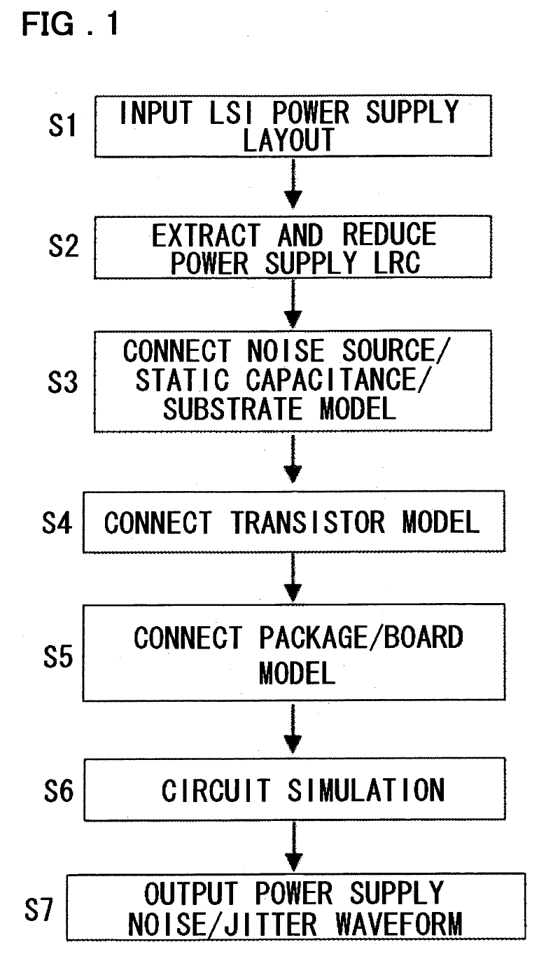

FIG. 1 depicts a flowchart of the first embodiment.

In a step S1 “input LSI power supply layout”, the LSI power supply layout information is entered in a pre-existing data form, such as DEF or GDS2. Alternatively, the power supply layout information (pitch or width of the interconnection) of the initial designing stage, such as a floor plan, is entered.

In the next step S2 “extract and reduce power supply LRC”, layout parameters (inductance, resistance and capacitance) are extracted for the above power supply layout to formulate a power supply model. The circuit parameters extracted are reduced, as necessary.

In the next step S3 “connect noise source/static capacitance/substrate model”, a model for the noise source, static capacitance and a silicon substrate for the above power supply model is prepared, as necessary, and connected to the power supply model.

The noise source may be modeled as a current source element employing a simplified power supply current waveform formulated based on e.g., the power consumption. On the other hand, the static capacitance may be calculated by calculating the capacitance per cell, using device parameters from a cell library, and by then multiplying the so calculated capacitance with the number of cells as obtained from the cell data. The substrate model may be modeled by preparing an orderly resistance mesh, e.g., based on the resistivity of the substrate material, and by connecting the so prepared resistance mesh to the above power supply model via a resistor or resistors.

In the next step S4 “connect transistor model”, a SPLICE model (model for circuit simulation) of a transistor is connected to the above-mentioned power supply model, as a circuit acting as a noise source, or a circuit subjected to noise. In this case, reference may be made to the layout data in order to determine the position of connection to the power supply model. The transistor models may also be connected to one another as necessary.

In the next step S5 “connect package/board model”, the model of the LSI package and the board (printed circuit board) is connected to the above power supply model (or to a device connected to the above power supply model). For the package/board model, a simplified concentrated constant model may be used. Alternatively, the model may be formulated using an extraction program.

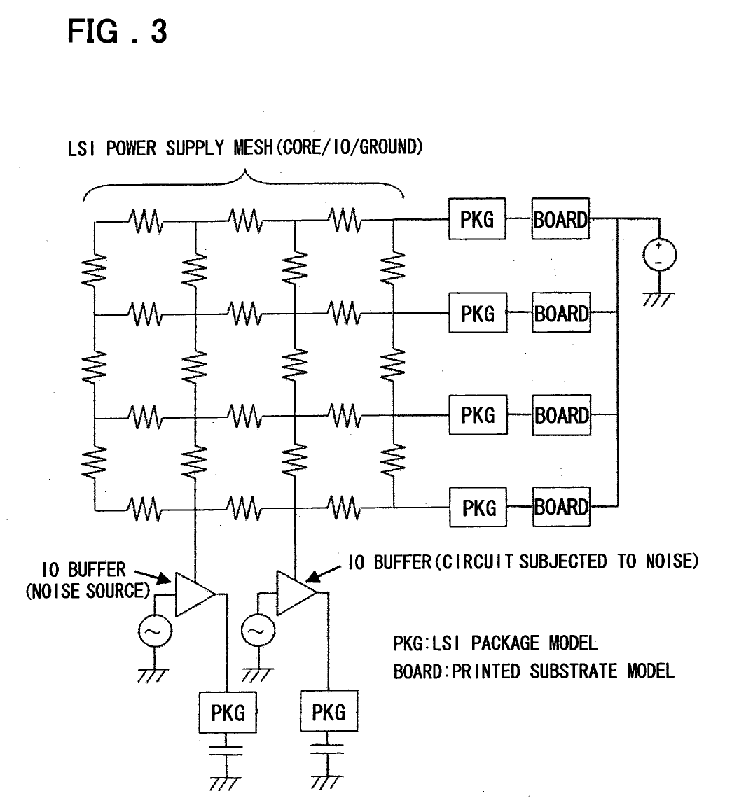

For connecting the respective models to the power supply model, in the above steps S3 to S5, reference may be made to the layout data to determine the position of connection to the power supply model. FIG. 3 shows an example of an analysis model formulated by the above steps S1 to S5.

In the next step S6 “circuit simulation’, circuit simulation is carried out under preset conditions, using the models for analysis, prepared as described above.

In the final step S7 “output power supply noise/jitter waveform”, the waveform of the power supply noise or the jitter is output, based on the results of the above circuit simulation.

Meanwhile, the processing for jitter analysis of the above steps S1 to S7 may be carried out on a computer, such as EWS, in accordance with a program. In this case, the computer for executing the program becomes the apparatus for jitter analysis shown in FIG. 6.

With the present first embodiment, in which the power supply LRC is extracted and modeled to carry out circuit simulation, the circuit simulation for analysis of power supply noise or jitter may be executed accurately speedily.

Moreover, since the simulation for finding the power supply noise waveform and the simulation for analyzing the jitter are carried out simultaneously at a time, there is merit that, in case the circuit scale is not so large, the desired result may be obtained by a sole operation for simulation.

### SECOND EMBODIMENT

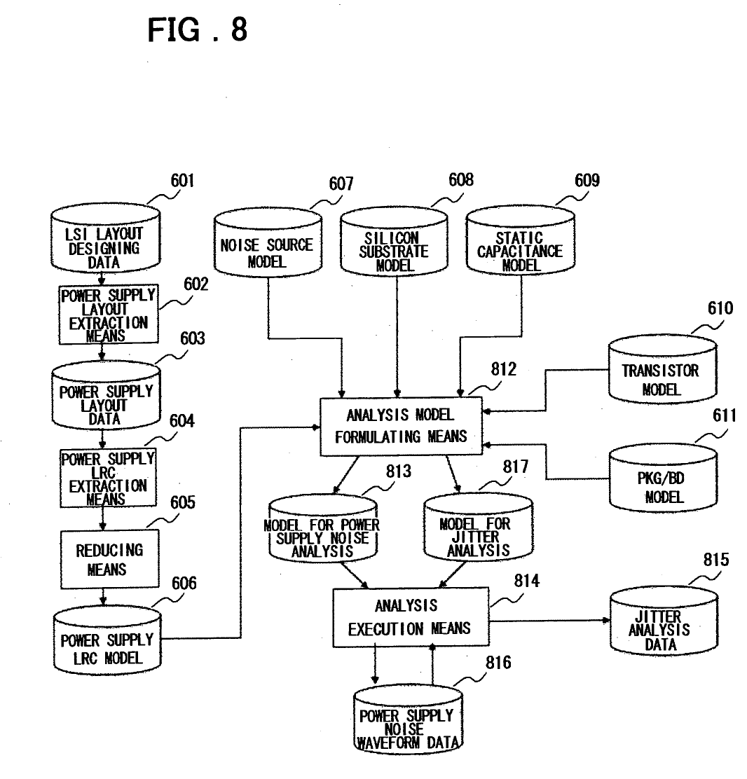

A second embodiment of the present invention will now be explained. FIG. 8 depicts a block diagram of an apparatus for jitter analysis according to the second embodiment of the present invention.

In the second embodiment, the blocks similar in configuration and operation to those of the jitter analysis apparatus of the first embodiment are denoted by the same reference numerals as those of the first embodiment, and the corresponding description is omitted for simplicity. The jitter analysis apparatus of the second embodiment differs from the apparatus of the first embodiment in that analysis model formulating means 812 separately outputs a model for analysis of the power supply model 813 and a model for jitter analysis 817, and in that analysis executing means 814 causes power supply noise waveform data 816, obtained as a result of the circuit simulation, to be stored in e.g. a file, and exploits the power supply noise waveform data 816, stored in e.g. the file, as input data, to carry out the circuit simulation, when the analysis is to be effected next time.

The processing flow of the second embodiment of the present invention will now be explained.

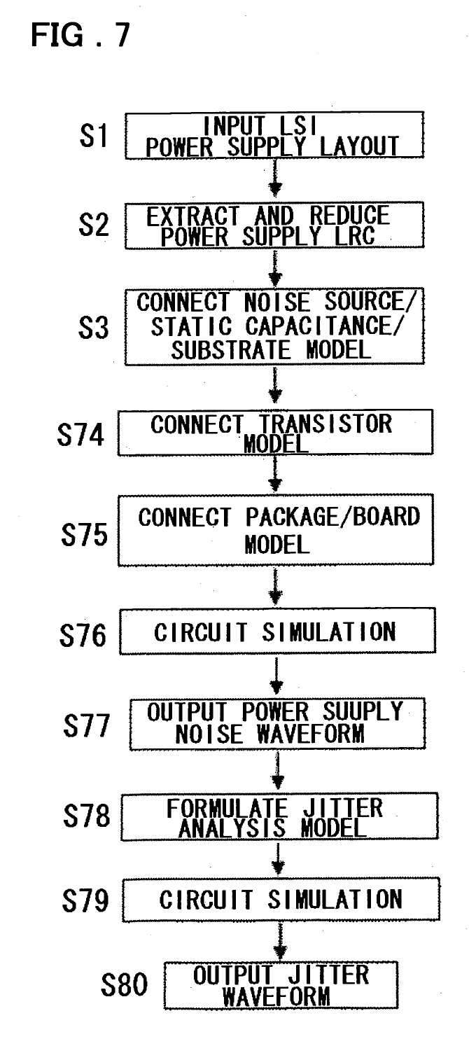

FIG. 7 depicts a flowchart of the second embodiment. The processing steps similar to those of the flowchart of the first embodiment are depicted by the same reference numerals used for the second embodiment and the corresponding description is omitted for simplicity. The second embodiment differs appreciably from the first embodiment in that the circuit simulation is carried out in two steps, that is, a step of “output power supply noise waveform” S77 for finding the power supply noise waveform and a step of “formulate jitter analysis model” S78 for carrying out jitter analysis. In the first circuit simulation step S76, those circuits needed for jitter analysis but unneeded for power supply noise analysis, for example, PLL, may be omitted from the analysis model. Thus, in the transistor model connection step S74, only the circuit of the transistor model, needed for analysis of the power supply noise, is connected to prepare a model for analysis of the power supply noise 813. It is noted that models unneeded for power supply analysis, if any, may be omitted from connection, in the package/board model connection step S75 as well.

In the step of “output power supply noise waveform” S77, the power supply noise waveform, output from the circuit simulation step S76, is output to and stored in e.g., a file, as power supply noise waveform data 816.

In the next step S78 “formulate jitter analysis model”, a model for jitter analysis 817 is prepared. Since the power supply noise waveform is already saved as the power supply noise waveform data 816, it is sufficient to prepare a model for jitter analysis 817 based only on e.g. transistors needed for jitter analysis, while the transistors needed only for power supply noise analysis may be omitted.

In a “circuit simulation” step S79, a power supply noise waveform, stored in a file in the step S77 “output power supply noise waveform”, is used, and circuit simulation is carried out for the jitter analysis model prepared in the step S78 “formulate jitter analysis model”, and the jitter waveform is output as jitter analysis data 815.

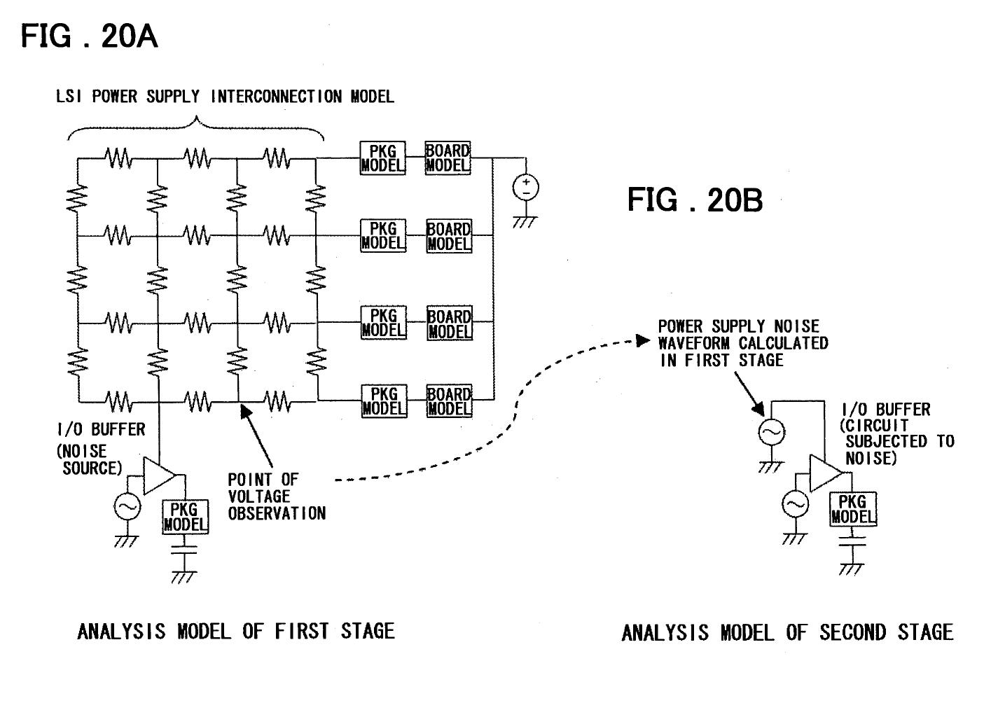

FIG. 20 depicts an analysis model diagram for illustrating the difference in the concept between the model for analysis of the power supply noise 813 and the model for jitter analysis 817. The model for analysis of the power supply noise 813 of the first stage and the model for jitter analysis 817 of the second stage are shown in FIGS. 20A and 20B, respectively.

In the model for analysis of the power supply noise 813 of the first stage, power supply voltage variations (power supply noise waveform) in the power supply part of the circuit suffering from noise, are observed in a model from which the circuit suffering from noise has been omitted, as shown in FIG. 20A.

In the model for jitter analysis 817 of the second stage, simulation is carried out for the circuit model made up by the circuit suffering from noise and a voltage source element, as shown in FIG. 20B, to calculate the jitter waveform. For the voltage waveform of the voltage source element, supplying the supply power to the circuit suffering from noise, the power supply noise waveform data 816, calculated in the aforementioned first stage, is used.

Although only one power supply noise waveform is given in FIG. 20B, the power supply noise waveform not only for VDD but also that for GND may be observed by the first stage circuit simulation and stored as the power supply noise waveform data 816 for use in the analysis of the second stage. It is noted that, in such case, the voltage source element having the waveform for GND is connected to a GND terminal of the circuit suffering from noise.

If the circuit suffering from noise is connected to plural power supply systems, the power supply noise waveform may be imparted in similar manner to each of these power supply systems.

In the above-described second embodiment of the present invention, in which simulation for calculating the power supply noise waveform and simulation for calculating the jitter waveform are carried out separately, it is possible to omit unneeded portions of the analysis models used in any of the two simulations, such as power supply interconnection models in the jitter analysis, and hence the scale of the analysis model can be reduced. Hence, a higher processing speed for analyzing a large scale LSI is possible.

Moreover, if once the power supply noise waveform is obtained followed by jitter analysis carried out under variable conditions, it is possible to dispense with the step of calculating the power supply noise waveform, from one jitter analysis to another, thus assuring efficient processing.

In general, the jitter analysis is in need of a very long period of time for the subject of analysis. However, since it is not of a particular problem to use a short period of time for carrying out the analysis for calculating the power supply noise waveform, optimum time durations may be set for the simulation for calculating the power supply noise waveform and for that for calculating the jitter waveform, thereby enabling efficient processing.

### THIRD EMBODIMENT

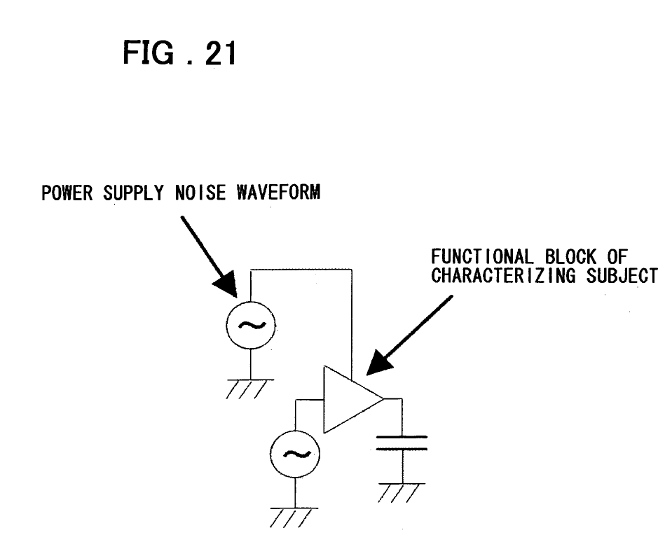

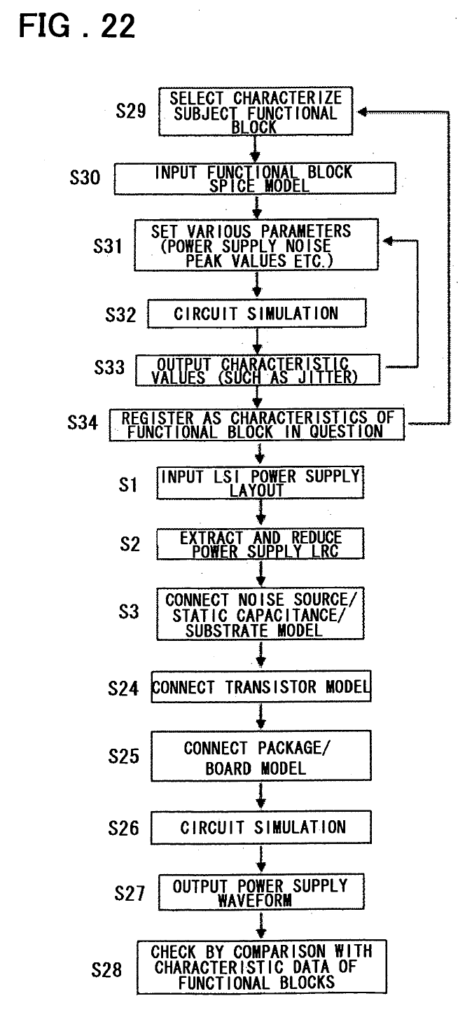

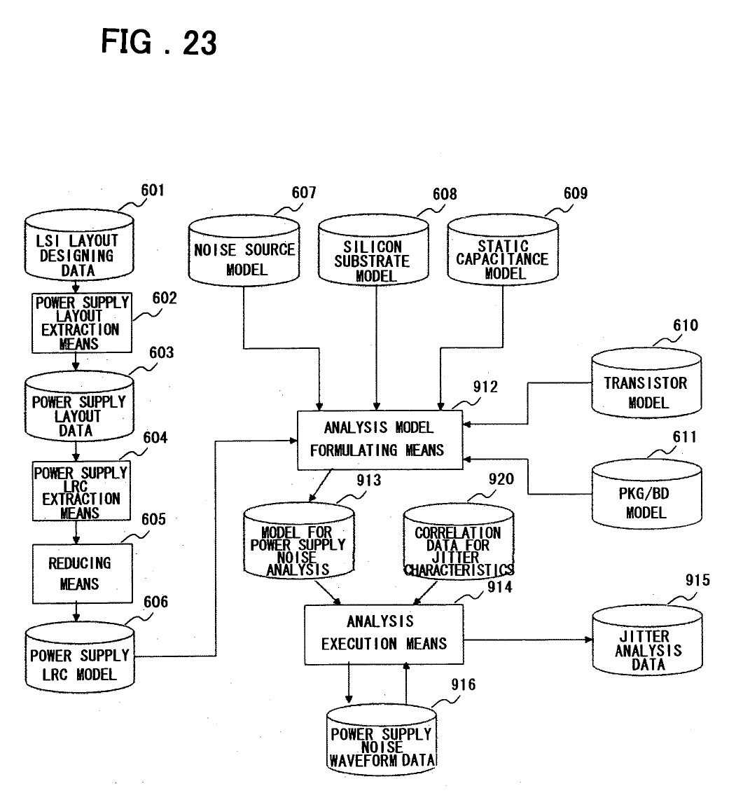

A third embodiment of the present invention will now be explained. FIG. 21 shows a functional-block-based jitter analysis model of the third embodiment of the present invention, FIG. 22 depicts a flowchart for illustrating the jitter analysis method, and FIG. 23 is a block diagram showing an apparatus for carrying out jitter analysis.

Referring first to FIG. 23, the configuration of the jitter analysis apparatus according to the third embodiment will now be explained. The present third embodiment differs from the first and second embodiments in that, for the functional blocks, as the subject of jitter analysis, data of correlation among the input signal waveform, power supply noise waveform and jitter characteristics are registered at the outset as jitter correlation data 920. It is noted that, although analysis means 914 carries out simulation for finding the power supply noise waveform, it does not have to carryout circuit simulation for jitter analysis, and hence it is only necessary for the analysis model formulating means 912 to formulate a model for analysis of the power supply noise 913. On the other hand, analysis execution means 914 executes jitter analysis, without executing circuit simulation, using power supply noise waveform data 916, obtained by the circuit simulation for analysis of the power supply noise, and correlation data 920 between the functional-block-based power supply noise and jitter characteristics.

Referring to the flowchart of FIG. 22 of the third embodiment, the sequence of jitter analysis will be explained. The processing of steps S29 to S34 is the processing for registering the correlation between the power supply noise and jitter characteristics for the functional blocks which may be the subject (object) for jitter analysis.

In the steps S29 to step S34, the resistance against noise, that is, the correlation between the power supply noise and jitter characteristics, is measured and registered as features of the respective blocks. The resistance against noise is expressed as numerical values representing the magnitude of the jitter and the noise of the output buffer waveform for e.g. a specified power supply noise waveform.

The processing similar to the jitter analysis flow of the above-described second embodiment (step S1 to S26) is then carried out to calculate the power supply noise waveform in a “circuit simulation” step S26. In this embodiment, the power supply noise waveform power supply noise waveform and jitter characteristics, such as variations in the output waveform, are registered at the outset for the respective functional blocks included in the circuit the jitter characteristics of which are to be found. Consequently, the second circuit simulation equivalent to the circuit simulation step S79 for the jitter analysis as in the second embodiment is unneeded, it being sufficient to compare the power supply noise waveform to the resistance against noise in the respective functional blocks in the step S28 to check if there is any problem in connection with jitter or noise.

The method for characterizing the resistance to the noise, and the correlation between the power supply noise waveform and jitter characteristics, as used in the third embodiment, will now be explained. The resistance to noise is calculated for the respective functional blocks, as the subject (object) of characterization, in the following manner:

First, using a SPICE model of the functional block in question, a jitter analysis model shown in FIG. 21 is prepared.

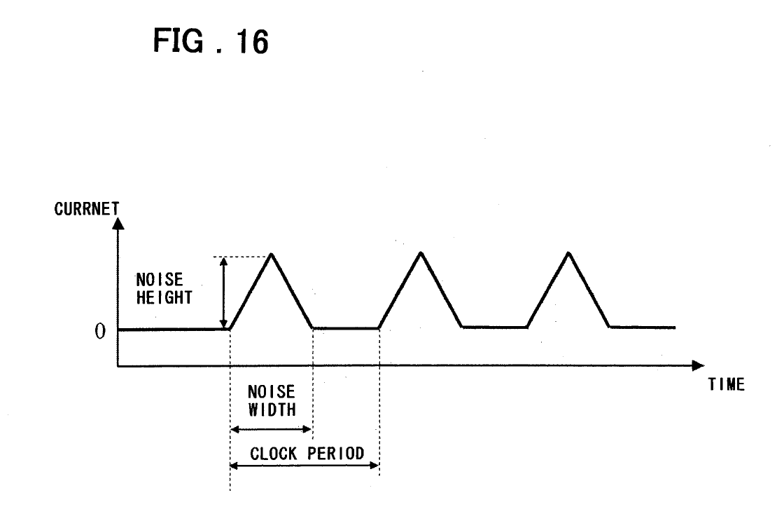

A plurality of sets each of a peak value and a noise width of the power supply noise waveform as used for jitter measurement (for example, triangular waveform shown in FIG. 16) are set, and jitter analysis is then carried out for each combination of the peak values and the noise widths.

For example, p1, p2 and p3 as peak values of the power supply noise and w1, w2 and w3 as noise widths (lengths) thereof are set, and jitter analysis is carried out for nine combinations of the peak values and the noise widths.

The values of the jitter calculated (magnitude of delay variation), thus calculated, are registered in a two-dimensional table having the noise peak values and the noise widths as keys. The registered values stand for correlation data for jitter characteristics 920 as the information characterizing the resistance to the noise.

For actually checking the power supply noise, using this characterizing information, the analysis means 914 effects linear interpolation, with the aforementioned two-dimensional table, from the noise peak value and the noise width of the power supply noise waveform of the power supply noise waveform data 916, obtained on circuit simulation, to calculate the jitter (quantity of delay variations). If the jitter calculated is larger than a predetermined reference value, it is verified that there persists the problem of jitter and the floor plan or the power supply interconnection/power supply terminal layout is corrected accordingly.

Up to now, in case the jitter analysis is carried out after layout designing, and the problem of jitter is found to persist, it is difficult to change the design drastically, such that it may become necessary to revert to the initial designing stage to effect design changes, thus appreciably raising the design change costs.

Conversely, with the third embodiment of the present invention, the problem of the power supply noise or jitter can be checked at the initial stage of designing, such as during mapping out a floor plan, so that it is possible to prevent the designing cost from increasing with re-designing. Consequently, the present flow may efficaciously be applied in the initial designing stage, such as mainly in the preparation of the floor plan or in the arraying of power supply terminals.

### EMBODIMENT OF ANALYSIS MODEL

An embodiment of an analysis model, used common in the first to third embodiments of the present invention, will be explained in more detail.

[1] Modeling Technique For Power Supply Interconnection And Silicon Substrate

A model for power supply interconnection is formulated for each small area (power supply cell) obtained on dividing a chip layout area in a lattice pattern.

The modeling method for each power supply cell will now be explained.

For all the interconnection segments in a power supply cell, resistance R, self-inductance L and mutual inductance K are obtained. The number of K elements is reduced by the double-inverse method which guarantees the passivity of the whole circuits.

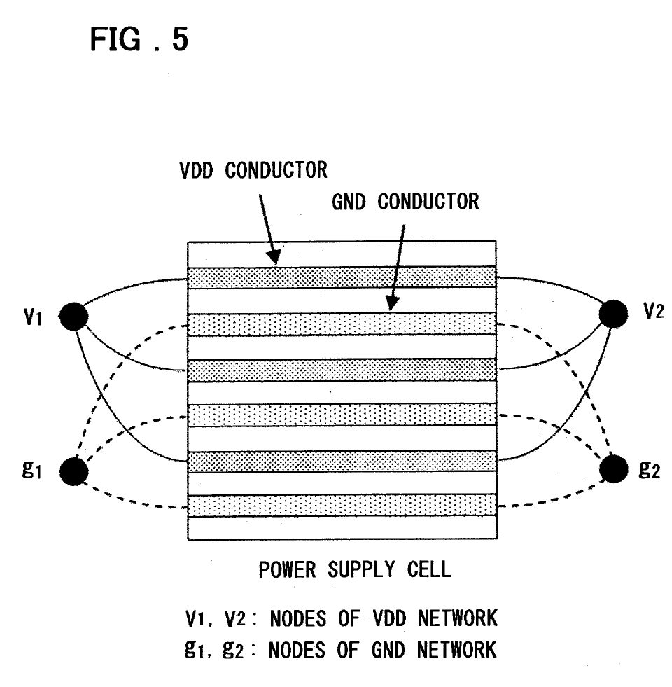

On the opposite sides of the cell are fitted terminals (v1, v2, g1 and g2 in FIG. 5) for each network. The ends of the networks on the sides fitted with the terminals are shorted with respect to each network and connected to the relevant terminals.

The terminals v2 and g2 of FIG. 5 are then shorted to calculate the impedance Zloop across the terminals v1 and g1.

The impedance Zg across the terminals g2 ad g1 is then calculated.

The effective resistances Rv, Rg and the effective inductances Lv, Lg in the transverse direction of the VDD conductor network and the GND conductor network are then found in accordance with the following equations (1) to (4):
Rg=Re(Zg)/2 (1)
Lg=Im(Zg)/2 (2)
Rv=Re(Zloop−Zg)/2 (3)
Lv=Im(Zloop−Zg)/2 (4).

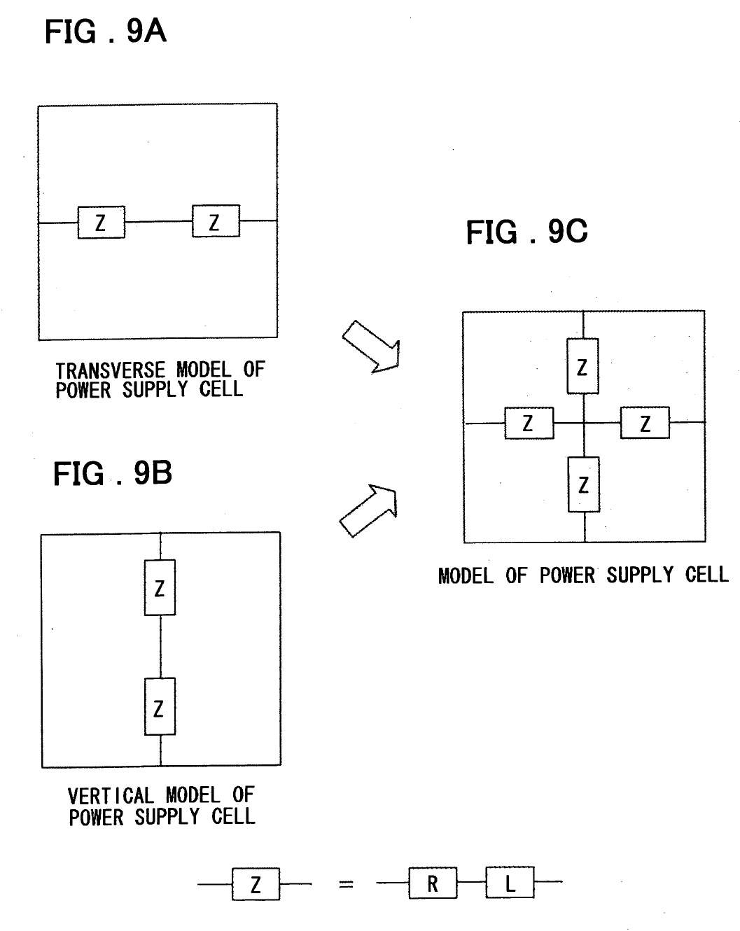

A model shown in FIG. 9A may be formulated by the above equations (1) to (4). The effective resistance and the effective inductance in the vertical direction are then found in the same way as for those for the transverse direction to formulate a model shown in FIG. 9B. The two models are connected (combined) to each other at the center of the power supply cell to complete a model shown in FIG. 9C. This model is formulated from one network to another. Thus, if there are three power supply networks VDD1, VDD2 and GND in a single power supply cell, three models, such as shown in FIG. 9C, are formulated for the power supply cell in question.

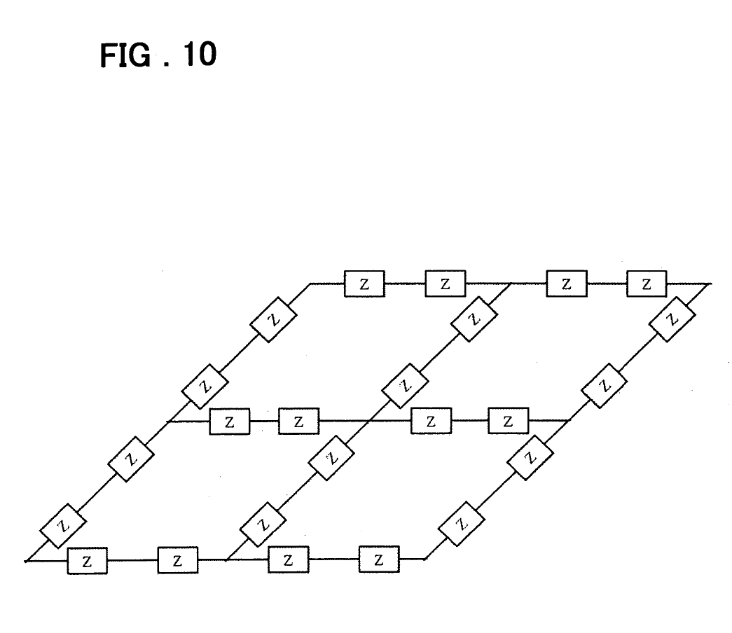

The models of the power supply cells are connected from one power supply network to another to complete a model of the power supply network of the entire chip, as shown in FIG. 10. It is noted that, if there are three power supply networks, three such models of the power supply networks are formed.

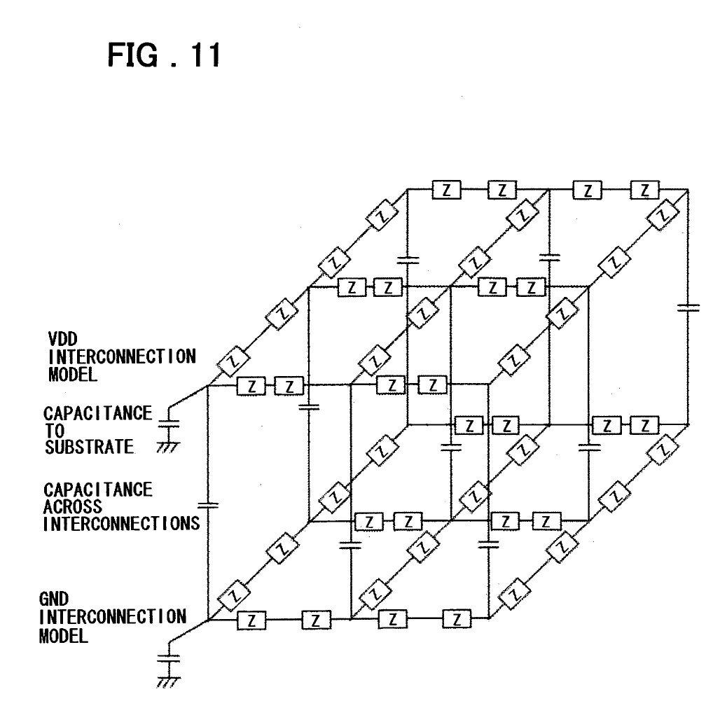

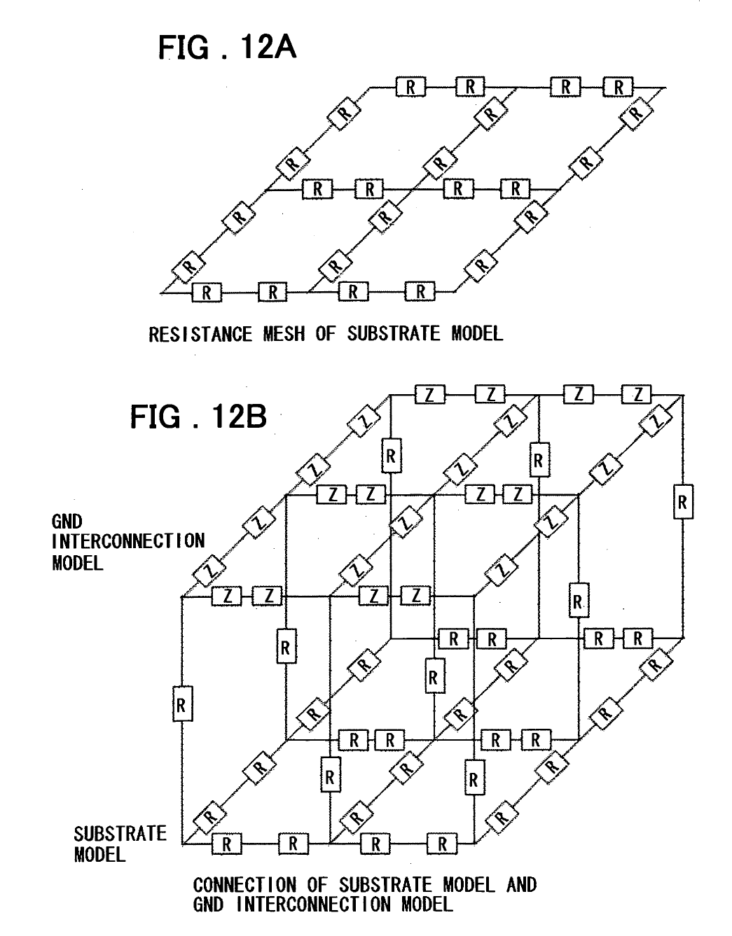

Then, capacitances across different power supply networks, such as VDD or GND, are calculated, and capacitor devices, such as those shown in FIG. 11, are inserted. The capacitance across the power supply network and a silicon substrate (capacitance relative to the substrate) may be calculated and inserted as a capacitance with reference to the absolute ground. The silicon substrate is modeled as a mesh of resistors, as shown in FIG. 12A. This resistor model (substrate model) is connected to the model of the GND conductor, as shown in FIG. 12B. Resistor devices are inserted across the substrate model and the GND conductor model.

The resistance value of the substrate model (resistance value per resistor device included in the resistor mesh) may be calculated in accordance with the following equation (5):
R₁=ρₕ/tₕ (5)
where ρₕ is the resistivity of a highly-doped substrate and tₕ is the thickness of the highly-doped substrate.

On the other hand, the value of the resistor inserted across the substrate model and the GND conductor model (resistance value per one resistor device) may be calculated in accordance with the following equation (6):
R₂=ρₑ×(tₑ−t_{w})/a (6)
where ρₑ is the resistivity of an EPI layer, tₑ is the thickness of the EPI layer, t_{w} is the well thickness and “a” is an area of a power supply cell.

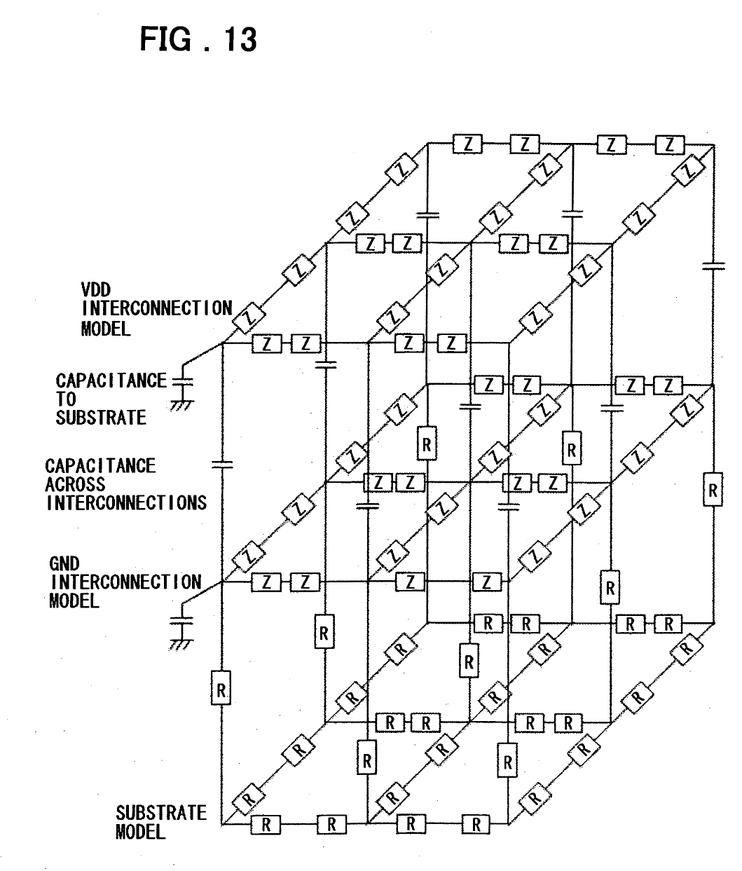

FIG. 13 shows an example of a model obtained on interconnecting the VDD network, GND network and the substrate model.

[2] Speedup By Pattern Matching

With the above-described power supply cell modeling method, in which the circuit simulation needs to be carried out from one power supply cell to another, the simulation generally has to be carried out a number of times, thus leading to a prolonged length of processing time. Thus, for shortening the processing time, cell models are not extracted from the cells deemed to be of the same power supply interconnection pattern as the cell from which a model has already been extracted, and a model already extracted is applied.

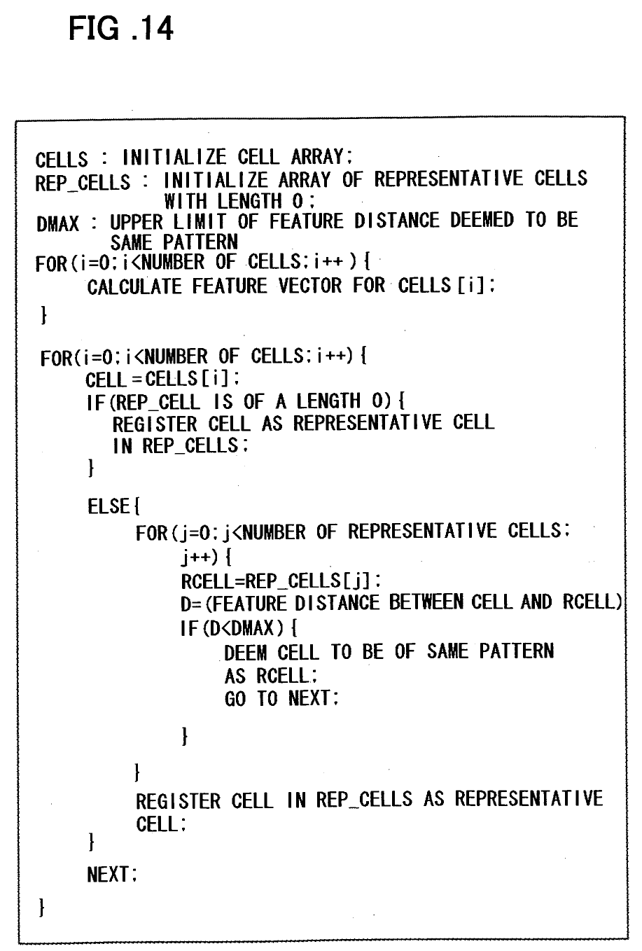

The degree of similarity of the interconnection (wiring) structure of the power supply cells is quantified as follows: For each power supply cell “c”, three values, namely an average wiring conductor width w, an average wiring conductor density “d” and a total area “a” of the wiring conductors, are calculated from one interconnection layer “i” to another and from one power supply system “j” to another to give a feature vector p_{c} ∈ R^{m} (m=3ij) comprising an array of the three values as follows:
p_{c}=<w₁, ₁, d₁, ₁, a₁, ₁, w₁, ₂, d₁, ₂, a₁, ₂, . . . , w₁, ₙ, d₁, ₙ, a₁, ₙ> (7)
where “1” and “n” denote the number of network layers and the number of power supply networks (number of power supply systems), respectively. After finding the feature vectors of all cells, the respective elements are normalized by the maximum values among all the cells. In case the feature vectors of two different power supply cells are p₁, p₂, the degree of similarity of the interconnection structures of these two power supply cells is expressed by the euclidean distance ∥p₁−p₂∥ and is termed the “feature distance between the power supply cells”. Using this feature distance, the patterns of the power supply cells are classified in accordance with the algorithm shown in FIG. 14.

First, the cell array of the entire cells “cells” and the array of representative cells “rep-cells” as the model cell, are initialized. The value of an upper limit “Dmax” of the feature distances, with which two power supply cells are deemed to be of the same pattern, is set. The feature vectors for all the “cells” are then calculated on computation. It is then checked for each cell whether or not the feature distance between the cell and any of the “representative cells” is less than the upper limit “Dmax”. If the result is affirmative, the pattern of the cell in question is deemed to be the same as the pattern of the representative cell and, if the feature distance between the cell in question and any of the representative cells is not less than the upper limit, the pattern of the cell in question is registered as a new representative cell. This processing is carried out for all the cells.

The representative cells are determined in accordance with the above-described algorithm, and cell model calculations are carried out only for the representative cells. It is noted that a suitable value is set for the upper limit “Dmax” of the feature distance, based on which pattern identity is determined, by experimentation for several samples, so that the cell model error will fall within a desired range of accuracy.

[3] Noise Source Connection

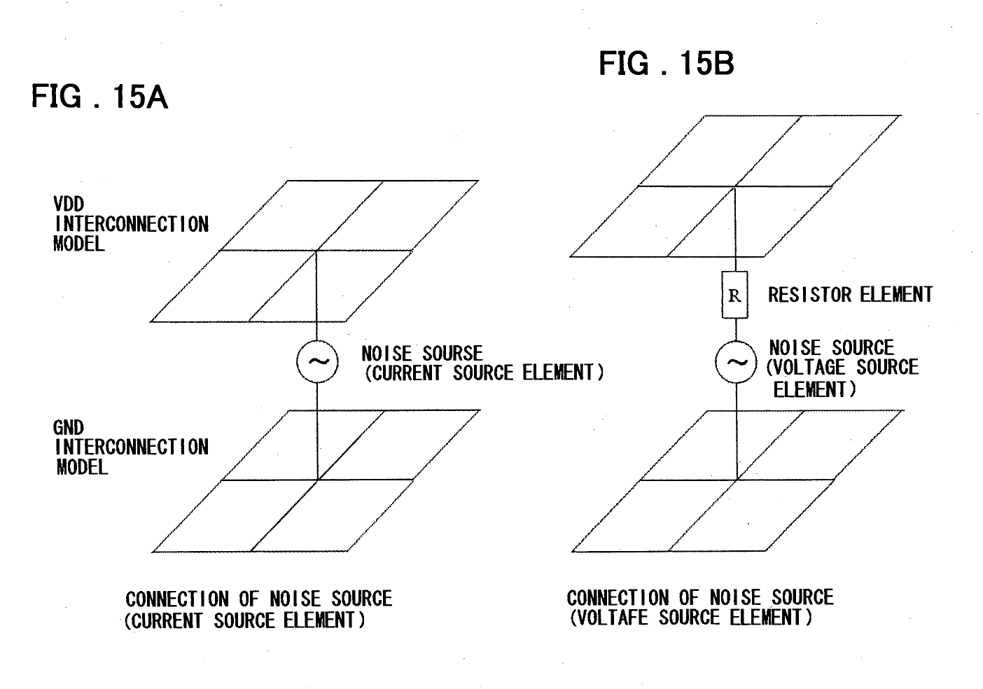

The noise source is modeled as a current source element (or as a voltage source element) and inserted across VDD and GND, as shown in FIG. 15A.

The current waveform of the current source element is a triangular waveform shown for example in FIG. 16. The width and the height of the noise of the triangular waveform may be determined as follows:

(A) Method For Determining the Noise Width

The circuit simulation for representative functional blocks when these are in operation is carried out to measure the power supply noise and a standard noise width is determined on the basis of the so measured power supply noise. This noise width is to be the noise of the triangular waveform.

(B) Method For Determining the Noise Height (Noise Peak Value)

The power consumption is calculated, from one power supply cell to another, based on the power consumption of the entire chip (that is, the power supply system in question), or from the power consumption of each functional block, and the noise height is determined so that the product of the average current (time-averaged value) of the current waveform and the power supply voltage will be equal to the aforementioned power consumption.

A resistor and a voltage source element may be substituted for the current source element, as shown in FIG. 15B.

[4] Connection of Static Capacitance

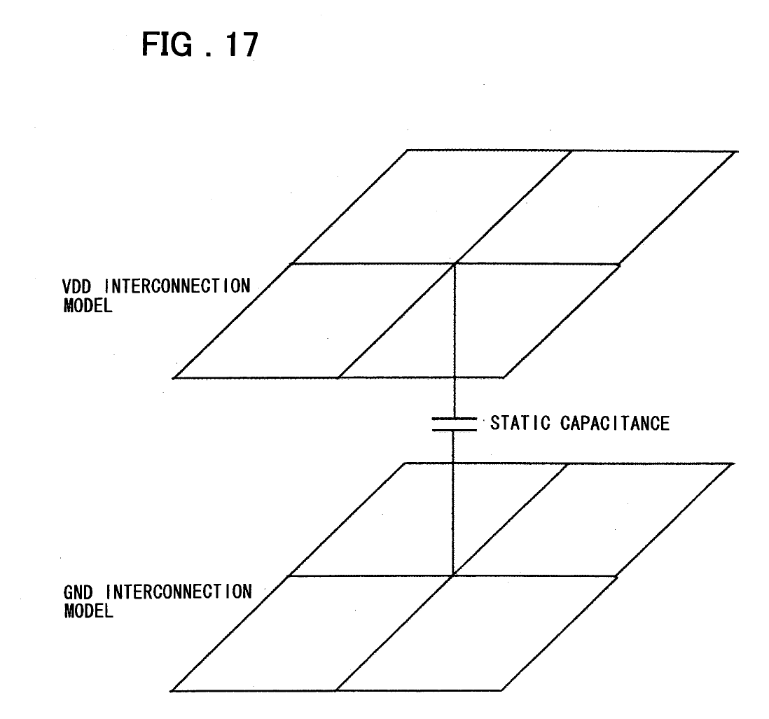

A model of static capacitance is formulated and connected to a current source model as shown in FIG. 17. The value of the static capacitance, connected across each VDD node and each GND node, may, for example, be calculated as follows: The values of the static capacitance are calculated for the totality of functional blocks in a chip supplied with the power from the power supply system in question, and summed up, so as to be then equally distributed to pairs of the VDD node and the GND node of the power supply system in question. Alternatively, the values of the static capacitance of the totality of the functional blocks in the power supply cell of the VDD/GND node in question, supplied with the power from the power supply system in question, are calculated and summed up. The sum static capacitance is used as the static capacitance of the power supply cell for the power supply system in question.

The static capacitance of each functional block may be calculated as follows: The gate capacitances of the respective transistors, included in the functional blocks, are calculated and summed up for use as the static capacitance of the functional block in question. If the operating factor rₐ of a transistor is known, the static capacitance may be calculated more accurately by multiplying the capacitance with (1−rₐ). The gate capacitance of a transistor may be calculated by multiplying the gate area of the transistor in question with a gate capacitance per unit area (as device parameter).

[5] Connection of Transistor Model

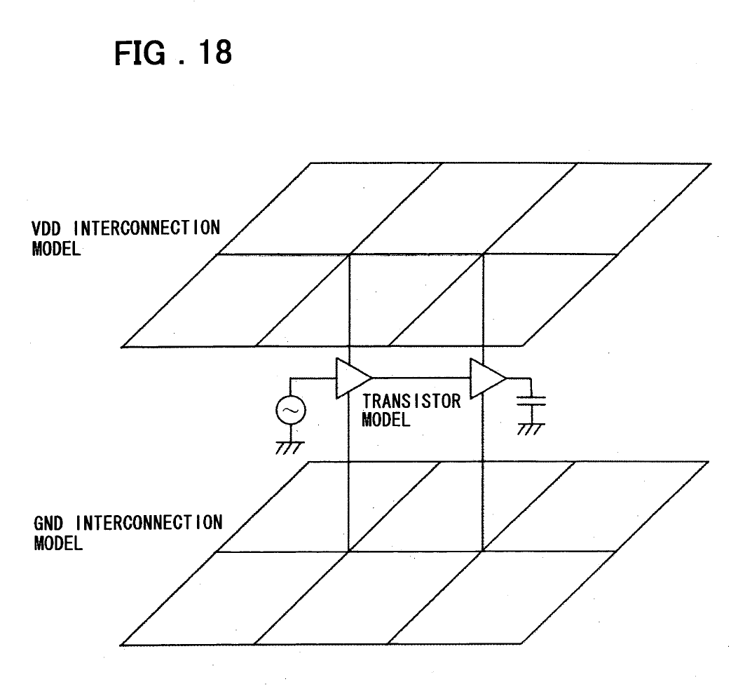

A SPICE model (model for circuit simulation) of a transistor is connected to the power supply model as a noise source or a circuit subjected to noise. The transistor models may be interconnected, or a power supply device, a capacitance device or the like is connected in place, as necessary. For example a transistor model may be connected across VDD and GND, as shown in FIG. 18.

[6] Connection of Package/Board Model

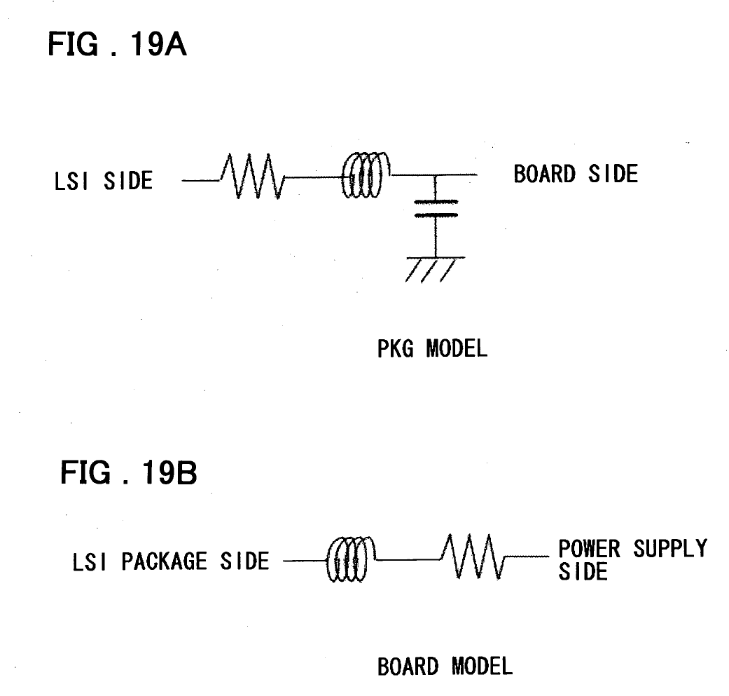

A model for a package and a model for board (printed circuit board) are interconnected as shown for example in FIG. 3. A simplified concentrated constant model may be used for a package/board model. FIGS. 19A and 19B show examples of a concentrated constant model. FIG. 19A shown a PKG model, whereas FIG. 19B a board model.

The present invention is not limited to the above-described embodiments and may be suitably modified and worked out within the range of the invention as explained in the specification and shown in the drawings.

For example, when the analysis model formulating means formulates an analysis model, the analysis model may be formulated as a package model, a board model or as a silicon substrate model are omitted. Moreover, when the transistor model itself is analyzed as a noise source, it is possible to omit the noise source model.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A method for analyzing jitter comprising the steps of:
formulating a power supply LRC model by extracting interconnection resistance, interconnection capacitance and interconnection inductance of a power supply from circuit layout data;
formulating an analysis model by connecting a transistor model to said power supply LRC model; and
effecting circuit simulation for said analysis model to output jitter analysis data.

2. The jitter analysis method as defined in claim 1, wherein
said analysis model comprises a power supply noise analysis model for simulating the power supply noise; and
said step of effecting circuit simulation for said analysis model comprises the steps of:
effecting a first circuit simulation for said power supply noise analysis model to find a power supply noise waveform;
formulating a jitter analysis model of a circuit as a subject of jitter analysis; and
effecting a second circuit simulation, using the power supply noise waveform, as found by said first circuit simulation, to output the jitter analysis data.

3. The jitter analysis method as defined in claim 1 further comprising the steps of:
effecting circuit simulation in advance from one functional block to another to find the correlation of the input signal waveform, power supply noise waveform and jitter characteristics, and
registering the correlation thus found as characteristics of the functional block in question;
wherein said step of effecting circuit simulation for said analysis model finds the power supply noise waveform by said circuit simulation and effects jitter analysis from the correlation of said pre-registered power supply noise waveform and the jitter characteristics to output jitter analysis data.

4. The jitter analysis method as defined in claim 1, wherein
said step of formulating the LRC model divides an area of the circuit layout to be analyzed into plural small areas in a lattice pattern, extracts the resistance, self inductance and mutual inductance of the power supply interconnection, from one small area to another, and finds equivalent resistance and equivalent inductance of the small areas in their entirety, based on the resistance, self inductance and mutual inductance of the power supply interconnection as extracted.

5. The jitter analysis method as defined in claim 1, wherein
said step of formulating the LRC model divides an area of the circuit layout to be analyzed into plural small areas in a lattice pattern, effects pattern matching of the small area, a model of which has already been formulated, to a power supply interconnection pattern, in formulating a model from one small area to another, and applies the model already formulated for an analogous small area without newly formulating a model.

6. The jitter analysis method as defined in claim 5, wherein a feature vector is found for the interconnection structure, from one small area to another, in effecting said pattern matching, and wherein the degree of analogousness of the interconnection structure is verified by Euclid distance between feature vectors.

7. The jitter analysis method as defined in claim 1, wherein
said circuit layout data comprises circuit designing data to be formed on a silicon substrate of a semiconductor integrated circuit, and
said step of formulating said analysis model comprises the steps of further connecting models of a noise source, static capacitance, a silicon substrate, a package of integrated circuits, a printed circuit board and a power supply to formulate an analysis model.

8. An apparatus for analyzing the jitter comprising:
power supply LRC model extracting means for formulating a power supply LRC model by extracting interconnection resistance, interconnection capacitance and interconnection inductance of a power supply from circuit layout data;
analysis model formulating means for formulating an analysis model by connecting a transistor model to said power supply LRC model; and
analyzing means for effecting circuit simulation on said analysis model to output jitter analysis data.

9. The apparatus for analyzing the jitter as defined in claim 8, wherein
said analysis model formulating means comprises: power supply noise analysis model formulating means for formulating a power supply noise analysis model for simulating power supply noise, and
jitter analysis model formulating means for formulating a jitter analysis model for simulating jitter analysis; wherein
said jitter analyzing means comprises:
power supply noise simulating means for effecting circuit simulation for said power supply noise analysis model to output a power supply noise waveform, and
jitter analysis simulating means for effecting circuit simulation using said power supply noise waveform for said jitter analysis model to output a jitter waveform.

10. The jitter analysis apparatus as defined in claim 8, further comprising
means for effecting circuit simulation in advance from one functional block to another to find correlation of input signal waveform, power supply noise waveform and jitter characteristics, and
jitter characteristic register means for registering the correlation thus found as characteristics of the functional block in question; wherein
said analysis means effects circuit simulation on said analysis model to find a power supply noise waveform and effects jitter analysis from the correlation between the power supply noise waveform and jitter characteristics as registered by said jitter characteristics register means.

11. The jitter analysis apparatus as defined in claim 8, wherein
said LRC model extracting means divides an area of the circuit layout to be analyzed into plural small areas in a lattice pattern, extracts the resistance, self inductance and mutual inductance of the power supply interconnection, from one small area to another, and finds equivalent resistance and equivalent inductance of the small areas in their entirety based on the resistance, self inductance and mutual inductance of the power supply interconnection as extracted.

12. The jitter analysis apparatus as defined in claim 8, wherein
said LRC model extracting means divides an area of the circuit layout to be analyzed into plural small areas in a lattice pattern, effects pattern matching of the small area, a model of which has already been formulated, to a power supply interconnection pattern, in formulating a model from one small area to another, and applies the model already formulated for an analogous small area without newly formulating a model.

13. The jitter analysis apparatus as defined in claim 8, wherein
said circuit layout data comprises circuit designing data to be formed on a silicon substrate of a semiconductor integrated circuit, and
said analysis model formulating means comprises means for further connecting a noise source, static capacitance, a silicon substrate, a package of integrated circuits, a printed circuit board and a power supply to formulate an analysis model.

14. A jitter analysis program for having a computer execute the method as defined in claim 1.

15. A jitter analysis program for having a computer operate as an apparatus as defined in claim 8.
